(19) United States
(12) Patent Application Publication
(10) Pub. No.: US 2011/0035413 A1
(43) Pub. Date: Feb. 10, 2011

(54) DIAMETER BUS COMMUNICATIONS BETWEEN PROCESSING NODES OF A NETWORK ELEMENT

(76) Inventors: Thierry Bessis, Naperville, IL (US); Alan Tang, QingDao (CN)

Correspondence Address: DUFT BORNSEN & FISHMAN, LLP, 1526 SPRUCE STREET, SUITE 302, BOULDER, CO, 80302, US

(21) Appl. No.: 12/936,245

(22) PCT Filed: Apr. 18, 2008
(86) PCT No.: PCT/US08/60866

§ 371 Date: Oct. 4, 2010

(51) Int. Cl. G06F 17/30

(52) U.S. Cl. 707/799; 707/802; 707/E17.005

(57) ABSTRACT

A Diameter bus between Diameter processing nodes of the same network element is disclosed herein. The Diameter bus includes a data structure that is used to transfer Diameter messages between the processing nodes. In doing so, the data structure avoids the overhead associated with SCTP, TCP, Ethernet, and/or IP encoding that is required by the Diameter base protocol. To ensure that the Diameter processing nodes operate as intended, the Diameter bus also includes a simplified Diameter transport structure such that Capabilities Exchange messaging between Diameter processing nodes is maintained as required by the Diameter base protocol. However, the simplified Diameter transport structure forgoes other functionality associated with the Diameter base protocol, such as the Device Watchdog messaging. By eliminating certain features of the Diameter base protocol as well as the SCTP/TCP/IP encoding and decoding associated with Diameter communications, processing performance of the network element can be substantially improved.

### BACKGROUND OF THE INVENTION

1. Field of the Invention

The invention is related to the field of communication networks and, in particular, to systems and methods for communicating between processing nodes of a network element.

2. Statement of the problem

The Diameter base protocol is an Authentication, Authorization, and Accounting (AAA) protocol that was derived from the Remote Authentication Dial In User Service (RADIUS) protocol. The Diameter base protocol is a Peer-To-Peer architecture where a “Diameter node” implementing the Diameter base protocol can function as either a client or a server depending on the network configuration. The term Diameter node herein refers to any functional element within a data network communicating via the Diameter base protocol, such as a process or a processing node that is operable with a network element.

Diameter nodes communicate with one another across a network by way of Diameter messages. A Diameter message is the base unit of the Diameter base protocol that one Diameter node uses to send a command or deliver a notification to other Diameter nodes. The data contained in the Diameter messages is transferred by a set of Attribute-Value-Pairs (AVPs). The AVPs carry the detail of AAA as well as routing, security, and capability information between Diameter nodes. For instance, the AVPs are used by the Diameter base protocol to support the transport of user authentication information for user authentication within a “Diameter server”. The AVPs also transport specific authorization information between “Diameter clients” and Diameter servers allowing peer Diameter nodes to decide whether a user's access request should be granted. While some Diameter messages are required by the Diameter base protocol, such as those relating to control and AAA, Diameter nodes typically generate Diameter messages that are application-specific and, thus, not defined in the Diameter base protocol. Such application-specific Diameter messages are referred to as Diameter application messages.

In Internet Multimedia Subsystem (IMS) architecture, IMS processing nodes exchange AAA information using the Diameter base protocol. For instance, after collecting a user's credentials, such as username and password, an IMS processing node functioning as a Diameter client sends an access request message to another IMS processing node serving the request. This Diameter server then authenticates the user based on the information provided by the Diameter client. If the authentication process succeeds, the user's access privileges are included in a response message to the Diameter client. Otherwise, an access reject message is sent to the Diameter client.

Before such AAA information may be conveyed between peer Diameter nodes, the Diameter nodes require the establishment of a transport connection between the nodes. Capabilities-Exchange messages defined in the Diameter base protocol are used to establish the transport connection between Diameter nodes. The Diameter nodes exchange the Capabilities-Exchange messages to allow the discovery of the Diameter nodes' identities and capabilities, such as protocol version number, supported Diameter applications, security mechanisms, and the like. Because the message exchange style of the Diameter base protocol is synchronous, each message request has a corresponding counterpart answer. Accordingly, the receiver of a Capabilities-Exchange-Request message generates and transmits a Capabilities-Exchange-Answer message to the original sender. The Diameter base protocol requires that Diameter clients support either Transmission Control Protocol (TCP) or Stream Control Transmission Protocol (SCTP), while Diameter servers support both protocols. Accordingly, Diameter messages such as the requisite Capabilities-Exchange messages and the Diameter application messages are formatted and processed using the appropriate transport protocol before they can be transported to a Diameter node. Once received, the Diameter node processes a Diameter message according to the appropriate transport protocol layer to extract the Diameter message. While this process is necessary for transferring Diameter messages between Diameter nodes across a communication network such as the Internet, the process substantially increases the overhead associated with the conveyance of a Diameter message. However, not all Diameter nodes are disparately separated by network element. For instance, multiple Diameter nodes may operate within a single network element for ready access to one another. This additional transport burden, therefore, reduces the processing performance of the network element with which the Diameter nodes are configured.

### SUMMARY OF THE SOLUTION

Embodiments of the invention solve the above and other related problems by providing a Diameter bus between Diameter processing nodes of the same network element. The Diameter bus includes a data structure that is used to transfer Diameter messages between the processing nodes. In doing so, the data structure avoids the overhead associated with SCTP/TCP, Internet protocol (IP), and/or Ethernet encoding that is required by the Diameter base protocol. To ensure that the Diameter processing nodes operate as intended, the Diameter bus also includes a simplified Diameter transport structure such that certain essential Diameter base protocol functionality is maintained. More specifically, the simplified Diameter transport structure provides the Capabilities Exchange messaging between Diameter processing nodes as required by the Diameter base protocol. However, the simplified Diameter transport structure forgoes other functionality associated with the Diameter base protocol, such as Device Watchdog messaging. By eliminating certain features of the Diameter base protocol as well as the SCTP, TCP, Ethernet, IP , and/or other external transport protocol encoding and decoding associated with Diameter communications, processing performance of the network element can be substantially improved. Additionally, the Diameter bus may reduce signaling delay between Diameter nodes since Diameter messages are not transported using SCTP/TCP/IP protocols. Yet, when it is necessary for a Diameter processing node to communicate with an external Diameter processing node, the Diameter base protocol stack is still available for the network element to format a Diameter message and transport it across the Internet via typical Diameter communications.

In one embodiment of the invention, network element includes a plurality of processing nodes and a Diameter bus. The Diameter bus is adapted to communicatively couple the processing nodes and includes a data structure. The plurality of processing nodes includes a first processing node adapted to generate a Diameter message and store the Diameter message in a location of a data structure. The plurality of processing nodes also includes a second processing node that is linked to the location of the data structure to retrieve the Diameter message from the location of the data structure. For instance, the Diameter bus may link the second processing node to the location of the data structure by way of a software pointer. The second processing node may retrieve the Diameter message by a dereferencing of the software pointer.

In another embodiment of the invention, a method of performing processing node communication includes providing a data structure within a network element. The network element includes first and second processing nodes. The method also includes generating a Diameter message from the first processing node for transfer to the second processing node and copying the Diameter message to a location in the data structure. The method further includes linking the second processing node to the location in the data structure to access the Diameter message and accessing the Diameter message, with the second processing node, from the location in the data structure.

In another embodiment of the invention, an IMS network element includes a plurality of IMS processing nodes, including first and second IMS processing nodes. The IMS network element also includes a communication interface adapted to communicate with an external IMS network element via a Diameter base protocol. The IMS network element also includes a Diameter bus adapted to communicatively couple the IMS processing nodes. The Diameter bus includes a data structure adapted to receive a Diameter message at a first storage location in the data structure from the first IMS processing node and to transfer the Diameter message to the second IMS processing node.

### DESCRIPTION OF THE DRAWINGS

The same reference number represents the same element or same type of element on all drawings.

FIG. 1 illustrates a communication network in an exemplary embodiment of the invention.

FIG. 2 illustrates processing nodes of a network element communicating via a Diameter Bus in an exemplary embodiment of the invention.

FIG. 3 illustrates processing nodes transferring Diameter messages in an exemplary embodiment of the invention.

FIG. 4 is a flow chart illustrating a method of performing Diameter messaging between processing nodes in an exemplary embodiment of the invention.

FIG. 5 illustrates IMS processing nodes communicating via a Diameter bus in an exemplary embodiment of the invention.

### DETAILED DESCRIPTION OF THE INVENTION

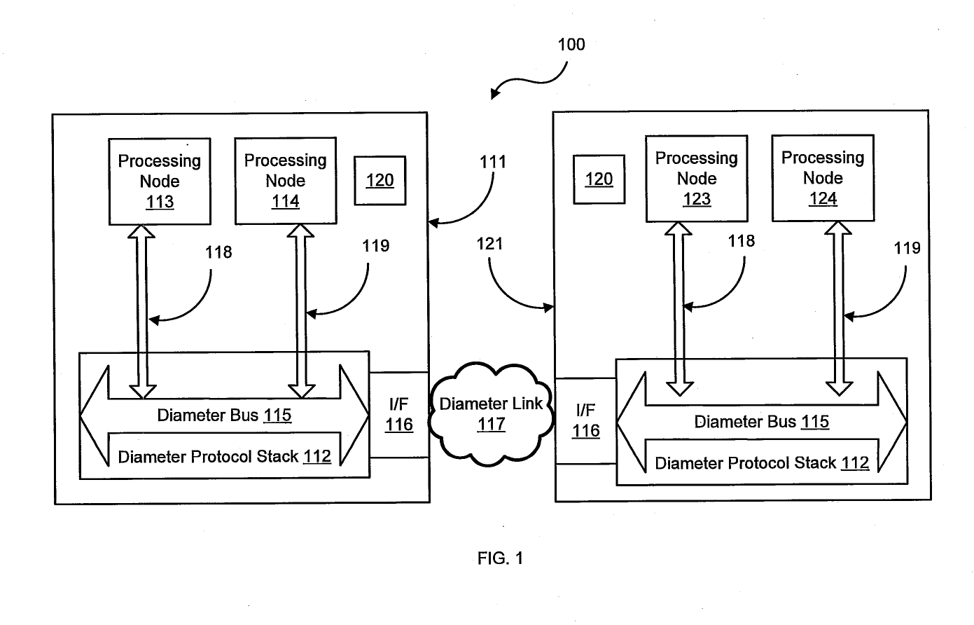

FIGS. 1-5 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates a communication network 100 in an exemplary embodiment of the invention. Communication network 100 includes a plurality of network elements 111 and 121 adapted to communicate with one another via the Diameter base protocol. A network element as used herein may be a computer system, such as a computer network server, operable to provide network communications within communication network 100. Each network element 111 and 121 may include a plurality of processing nodes (113, 114, 123, and 124) that perform certain functions within communication network 100. For instance, communication network 100 may be an IMS network used to deliver Internet multimedia services to mobile subscribers, such as cell phone users. Processing nodes 113, 114, 123, and 124 may have distinct IMS functionalities used to support the IMS network. To further illustrate, processing node 113 may be Call Session Control Function (CSCF) that performs Session Initiation Protocol (SIP) management for a subscriber requesting access to IMS services. Processing node 114, on the other hand, may be a Policy Decision Functional Element (PDFE) that determines resources, such as bandwidth, priority, etc., which should be allocated to a particular service instance of the subscriber. Because each processing node 113 and 114 is subscriber centric, the processing nodes 113 and 114, although having different functionalities, may require information from one another.

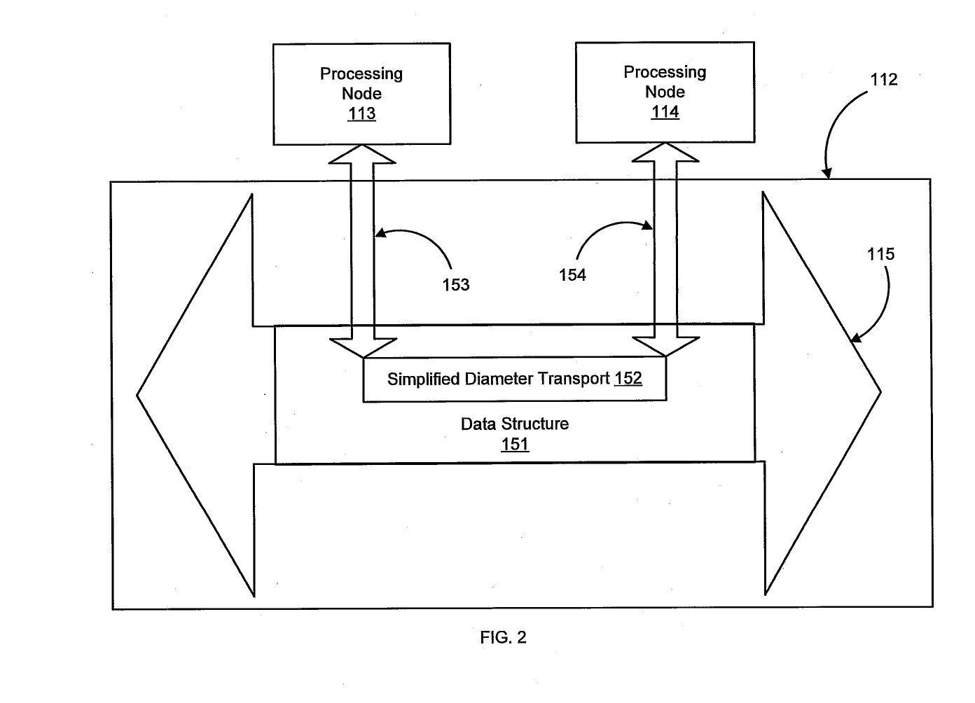

To establish communications between processing nodes of a network element, each network element (111 and 121) comprises a Diameter bus 115 that provides Diameter messaging capabilities for the processing nodes of their respective network elements. Regardless of the functional aspect of a particular processing node, processing nodes 113, 114, 123, and 124 are adapted to communicate with one another within their respective network elements 111 and 121 via their respective Diameter buses 115 in similar fashion. For the purposes of simplicity, reference will therefore be made to processing nodes 113 and 114 of network element 111. For instance, Diameter bus 115 provides Diameter internal messages between processing nodes 113 and 114. To provide these Diameter internal messages between processing nodes 113 and 114, Diameter bus 115 employs a data structure (FIG. 2) that links a Diameter message from processing node 113 to processing node 114, and vice versa, via communication links 118 and 119. This Diameter message linking between processing nodes 113 and 114 is performed without the overhead associated with SCTP/TCP, IP, and/or Ethernet encoding required by common Diameter base protocol messaging.

Diameter bus 115 provides basic functionality of the Diameter base protocol to ensure that a transport connection exists between processing nodes 113 and 114. This basic functionality may include Capabilities Exchange messaging when processing nodes 113 and 114 request communications from one another. For instance, when processing node 113 requires information from processing node 114, a transport connection is established between the processing nodes 113 and 114. To establish the transport connection, processing node 113 generates and transfers a Capabilities Exchange Request message to processing node 114. Processing node 114 processes the Capabilities Exchange Request message to determine whether it has anything in common with processing node 113. One example of such includes user information common to both processing nodes 113 and 114.

Generally, the Capabilities Exchange Request message and the Capabilities Exchange Answer message are exchanged the same way as the Diameter application messages. That is, the Capabilities Exchange Request/Answer messages may be transferred between the processing nodes 113 and 114 via the data structure. In this regard, the transport connection of Diameter bus 115 is a “virtual connection”.

To a processing node, the virtual connection of Diameter bus 115 is essentially the same as Diameter link 117. For instance, processing node 113 may send a Capabilities Exchange Request to processing node 114. In this regard, processing node 113 may input the Capabilities Exchange Request to a message queue from which processing node 114 retrieves the message. Processing node 114 may then extract an application identification and other information from the message and determine whether there is common application between processing nodes 113 and 114. If so, processing node 114 sends a Capabilities Exchange Answer message to processing node 113 to inform processing node 113 of the support for that application. Thereafter, the Diameter protocol stack 112 may represent the virtual connection of Diameter bus 115 between processing nodes 113 and 114 as an actual transport connection.

In this regard, Diameter bus 115 forgoes other portions of the Diameter base protocol, such as the SCTP/TCP/IP protocol suite, to provide a simplified Diameter transport structure between processing nodes 113 and 114. That is, Diameter bus 115 eliminates the overhead associated with TCP and/or SCTP encoding. Moreover, Diameter bus 115 eliminates the overhead associated with other forms of Diameter control messaging, such as Device-Watchdog messaging. For instance, in typical Diameter base protocol communications, transport failures are quickly detected to minimize the occurrence of messages being sent to unavailable agents and to improve failover performance. The Device-Watchdog-Request and Device-Watchdog-Answer messages are used to proactively detect such transport failures. Because processing nodes 113 and 114 are co-located within network element 111, the two processing nodes are not likely to fail unless the network element 111 itself fails. Accordingly, Diameter bus 115 simplifies the transport structure by removing the overhead associated with processing node failure detection within network element 111.

On occasion, a processing node of one network element may require information from a processing node of another network element separated by an Internet connection. In this case, a Diameter message, such as a Capabilities Exchange Request message may be generated and transferred from one processing node to another using the full Diameter base protocol stack 112. For instance, when processing node 114 requires information from processing node 123 of network element 121, processing node 114 may generate a Capabilities Exchange Request message that is SCTP encoded to allow connections that span multiple interfaces (multiple IP addresses). To do so, the Diameter base protocol requires that the Capabilities-Exchange-Answer message contain one Host-IP-Address AVP for each potential IP address that may be locally used when transmitting Diameter messages. The same is done when the processing node 123 replies to processing node 114 with a Capabilities Exchange Answer message. Diameter base protocol stack 112 provides processing nodes 113 and 114 the necessary features of the Diameter base protocol to prepare Diameter messages for transfer across communication network 100.

To transfer Diameter messages across communication network 100, network element 111 includes communication interface 116. Communication interface 116 may be an Internet communications interface or other physical interface, such as an Ethernet interface, that is used to transfer data between network elements 111 and 121. In this regard, communication interface 116 may transfer Diameter messages across communication network 100 to network element 121 via Diameter link 117. For instance, a transport connection between processing node 114 and 123 is established before Diameter messages may be exchanged. The transport connection is initiated through the assistance of the Capabilities Exchange messages of the Diameter base protocol. Once the transport connection is established, Diameter messages from processing node 114 to processing node 123, and vice versa, may be formatted according to the Diameter base protocol and encoded via SCTP or TCP. This encoding process provides address information, or routing information, to the Diameter messages such that the Diameter messages securely arrive at their intended destinations. This substantial use of the Diameter base protocol including the SCTP, TCP, Ethernet, and/or IP encoding thereby establishes Diameter link 117 between processing nodes 114 and 123.

With Diameter link 117 established between processing nodes 114 and 123, other features of the Diameter base protocol may also be employed. For instance, the Device Watchdog messaging described herein may be used to determine whether processing nodes 114 and 123 are operable so as to alleviate overhead associated with undeliverable Diameter messages. Those skilled in the art will appreciate that the invention is not intended to be limited to the Diameter link 117 communications between processing nodes 114 and 123. Rather, Diameter link 117 communications are merely exemplary of communications between processing nodes across communication network 100. Nor is the invention intended to be limited to any particular number of network elements or any particular number of processing nodes within a network element. Rather, communication network 100 merely exemplifies one manner in which Diameter communications may be provided between processing nodes within one network element as well as communications between processing nodes of multiple network elements.

FIG. 2 illustrates processing nodes 113 and 114 of the network element 111 communicating via Diameter Bus 115 in an exemplary embodiment of the invention. Diameter bus 115 includes data structure 151 for exchanging Diameter messages between processing nodes 113 and 114. For instance, processing node 113 may generate a Diameter message intended for processing node 114. Processing node 113 may then transfer the Diameter message to a location in the data structure via data link 153. Processing node 114 may be linked to data structure 151 via data link 154 to retrieve the Diameter message as it comes available.

Data structure 151 may be configured in a variety of ways. For instance, data structure 151 may be a message queue stored within storage element 120 of the network element 111 (see FIG. 1). Examples of storage element 120 include computer memory, computer disk drive space, and the like. To transfer a Diameter message from processing node 113 to processing node 114, processing node 113 may store the Diameter message in a memory location within the message queue. Processing node 114 may be linked to the memory location via a software pointer. Accordingly, processing node 114 may dereference the software pointer to the memory location and access the Diameter message.

Diameter bus 115 also includes a simplified Diameter transport structure 152 that establishes a simplified Diameter transport connection between processing nodes 113 and 114 using fewer features than are available with Diameter base protocol stack 112. In this regard, the simplified Diameter transport structure 152 may exchange Capabilities Exchange messages via data links 153 and 154 and data structure 151 between processing nodes 113 and 114. However, the simplified Diameter transport structure 152 may forgo other features of the Diameter base protocol, such as Device Watchdog messaging, that are typically necessary among Diameter communications across a communication network. Moreover, the simplified Diameter transport structure avoids the protocol layering overhead associated with TCP, SCTP, IP, and/or Ethernet. Yet, in providing the simple Diameter transport structure 152, processing nodes 113 and 114 are able to function as Diameter nodes without reconfiguration. That is, processing nodes 113 and 114 may continue to function as typical Diameter nodes.

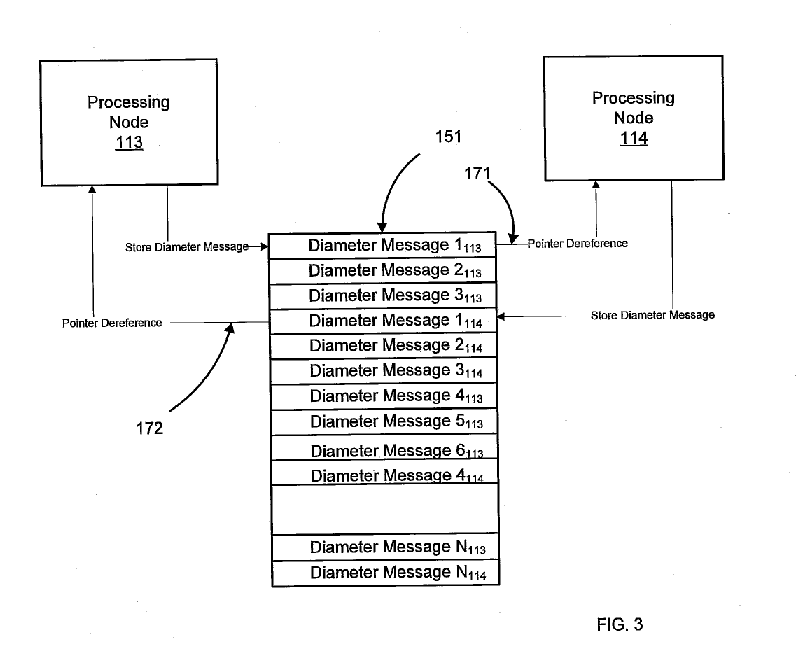

FIG. 3 illustrates Diameter nodes 113 and 114 transferring Diameter internal messages in an exemplary embodiment of the invention. As mentioned, data structure 151 may be configured as a message queue through which processing nodes 113 and 114 exchange messages by way of software pointers. For instance, processing node 113 may store Diameter message 1₁₁₃ at a location in data structure 151. Processing node 114 may be linked to the memory location through a software pointer 171. By a dereferencing of the software pointer 171, processing node 114 extracts Diameter message 1₁₁₃ from the memory location. Similarly, processing node 114 may store Diameter message 1₁₁₄ at another location in data structure 151 such that processing node 113, through a dereference of software pointer 172, may retrieve the message.

Generally, to retrieve a message, a “message thread” is generated for the Diameter protocol stack to retrieve the message from the message queue. For example, when processing node 113 places Diameter message 1₁₁₃ in data structure 151, a thread operable with processing node 113 may indicate such to a message thread operable by way of the Diameter protocol stack of network element 111. Diameter message 1₁₁₃ may include addressing to indicate source and destination nodes. In this regard, the message thread may retrieve Diameter message 1₁₁₃ and extract the address information to transfer the message to processing node 114 via the Diameter protocol stack. Thus, processing nodes 113 and 114 do not require direct access to the message pointers of data structure 151. Such a process may be similar to typical Diameter messaging without the overhead associated with the SCTP/TCP transport layer. Moreover, processing node 114 is “unaware” that Diameter message 1₁₁₃ was received from a processing node co-located within network element 111. The same process applies for processing node 114 transferring Diameter message 1₁₁₄ to processing node 113.

The naming convention of the Diameter messages shown in FIG. 3 is intended to illustrate the shared capability of data structure 151 in a nonlimiting fashion. For instance, this naming convention illustrates that processing node 113 may store Diameter messages 1 . . . N with the subscript numbers 113, wherein N is merely intended to represent an integer greater than 1. Similarly, processing node 114 may store Diameter messages 1 . . . N with the subscript numbers 114, wherein N is also merely intended to represent an integer greater than 1 although not necessarily equal to the number of Diameter messages from processing node 113. Further, the invention is not intended to be limited to the order in which Diameter messages are stored and/or retrieved from data structure 151. For instance, processing nodes 113 and 114 may store Diameter messages as memory comes available. Additionally, processing nodes 113 and 114 may retrieve Diameter messages from data structure 151 as they are needed and/or as they come available. Moreover, those skilled in the art will appreciate that variations of data structure 151 may be used to implement the message transfer between processing nodes of a single network element that do not require the overhead associated with the Diameter base protocol.

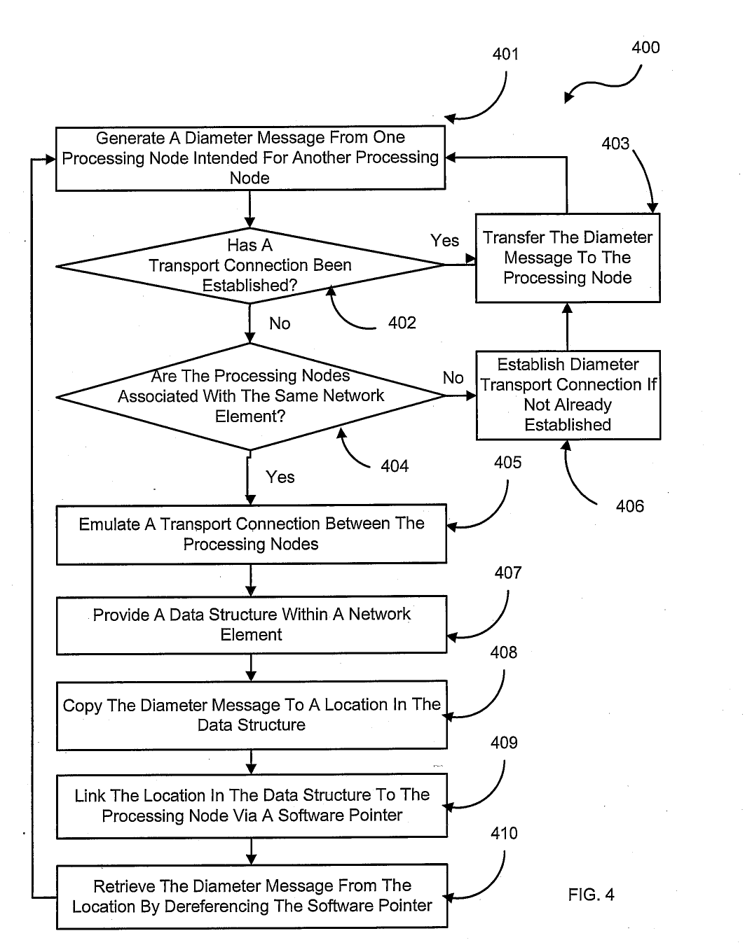

FIG. 4 is a flow chart illustrating a method 400 of performing Diameter node communication in an exemplary embodiment of the invention. In step 401, a processing node, such as processing node 113 of FIG. 2, generates a Diameter message intended for another processing node. In step 402, a determination is made as to whether a transport connection has been established between the two processing nodes. If a transport connection has been established, the Diameter message is transferred to the receiving processing node in step 403. The method 400 then returns to step 401 and another Diameter message is generated by a processing node. If, however, no transport connection has been established between the processing nodes, a determination is made as to whether the processing nodes are configured with the same network element, in step 404. For instance, if processing node 113 requires communications with processing node 124 of network element 121 of FIG. 2, a transport connection may be established between the two processing nodes, in step 406, if the connection has not already been established.

If, however, processing node 113 requires communications with processing node 114 within network element 111, then a transport connection is emulated between the two processing nodes in step 405. In one example of emulating a transport connection between processing nodes 113 and 114, a simplified Diameter transport structure 152 is provided between processing nodes 113 and 114. The simplified Diameter transport structure 152 emulates a Diameter link between processing nodes 113 and 114 via Capabilities Exchange messaging that forgo other features of the Diameter base protocol, such as Device Watchdog messaging and SCTP, TCP, Ethernet, and/or IP encoding.

The simplified Diameter transport structure 152 is generally part of a Diameter bus that establishes Diameter communications between processing nodes of the same network element. The Diameter bus also provides data structure 151, in step 407. In step 408, the processing node 113 copies the Diameter message to a location in the data structure. In step 409, the location in the data structure is linked to processing node 114. In one example, linking the location in the data structure to processing node 114 is performed by way of a software pointer. In this regard, the data structure may be a message queue where Diameter internal messages are stored and processing nodes access the Diameter internal messages by dereferencing software pointers. Accordingly, in step 410, processing node 114 may retrieve a Diameter message by dereferencing a software pointer pointing to the location of the Diameter message in the data structure. Method 400 continues so long as processing nodes, such as processing nodes 113, 114, 123, and 124, require Diameter messaging between one another. In this regard, method 400 returns to step 401 when a processing node generates a Diameter message intended for another processing node.

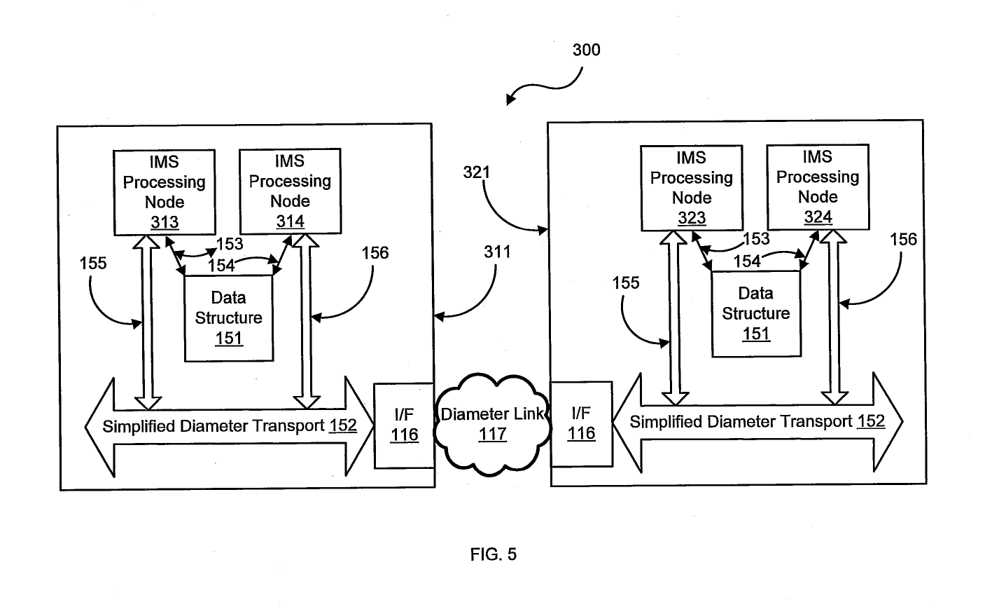

FIG. 5 illustrates IMS processing nodes 313, 314, 323, and 324 communicating via their respective Diameter buses in an exemplary embodiment of the invention. For instance, IMS processing nodes may require the exchange of AAA information. In this regard, IMS processing node 313 may require a user's credentials, such as a username and password, from another IMS processing node, such as IMS processing node 314. Since the IMS processing nodes 313 and 314 are co-located with the same IMS network element 311, Diameter messaging may be established through a Diameter bus that includes a simplified Diameter transport structure 152 and data structure 151 as described herein. The simplified Diameter transport structure 152 emulates a Diameter base protocol transport connection between the IMS processing nodes. Data structure 151 then provides the Diameter internal messaging capabilities by storing messages of one IMS processing node for access by another processing node. Accordingly, IMS processing node 313 may generate a Diameter internal message requesting the user credential information from the processing node 314. IMS processing node 313 may then store that Diameter internal message with the data structure 151 via link 153. The message is then linked to IMS processing node 314 via link 154 such that IMS processing node 314 may access the Diameter message.

In typical Diameter base protocol fashion, IMS processing node 314 may subsequently generate a Diameter message intended for IMS processing node 313 that either provides the user credential information or states that IMS processing node 314 is not in possession of such information. IMS processing node 314 may then store the Diameter message with data structure 151 via link 154 such that IMS processing node 313 may access the Diameter message via link 153.

As with the processing nodes of FIG. 1, the IMS processing nodes of one network element may still communicate with processing nodes of another network element using typical Diameter communications. For instance, IMS processing node 313 may establish a transport connection with IMS processing node 323 using the full Diameter base protocol stack 112 of FIG. 1. Once the transport connection is established, IMS processing node 313 may communicate with IMS processing node 323 via Diameter messages across Diameter link 117.

Although specific embodiments were described herein, the scope of the invention is not limited to those specific embodiments. The scope of the invention is defined by the following claims and any equivalents thereof

1. A network element, comprising:
a plurality of processing nodes comprising a first processing node adapted to generate a Diameter message and store the Diameter message in a location of a data structure, and comprising a second processing node that retrieves the Diameter message from the location of the data structure; and
a Diameter bus adapted to communicatively couple the processing nodes, wherein the Diameter bus comprises the data structure and wherein the second processing node is linked to the location of the data structure to retrieve the Diameter message from the location of the data structure.

2. The network element of claim 1, wherein the second processing node is linked to the data structure via a software pointer.

3. The network element of claim 2, wherein the second processing node is adapted to retrieve the Diameter message from the data structure by a dereferencing of the software pointer.

4. The network element of claim 1, further comprising a storage element adapted to allocate storage for the data structure, wherein the data structure is a message queue adapted to store Diameter messages generated by the processing nodes.

5. The network element of claim 1, wherein the Diameter bus emulates a transport connection between the first and second processing nodes using Capabilities Exchange messages of a Diameter base protocol.

6. The network element of claim 1, further comprising a communication interface adapted to communicate with an external network element via a Diameter base protocol, wherein the first processing node is adapted to format a Diameter message according to the Diameter base protocol for transport to the external network element via the communication interface.

7. The network element of claim 1, wherein the processing nodes are IMS processing nodes.

8. A method of performing processing node communication, the method comprising:
providing a data structure within a network element, wherein the network element comprises first and second processing nodes;
generating a Diameter message from the first processing node for transfer to the second processing node;
copying the Diameter message to a location in the data structure;
linking the second processing node to the location in the data structure to access the Diameter message; and
accessing the Diameter message, with the second processing node, from the location in the data structure.

9. The method of claim 8, wherein providing a data structure with the network element comprises:
allocating computer memory within the network element; and
establishing a message queue in the computer memory for software pointer access to Diameter messages.

10. The method of claim 8, wherein linking the second processing node to the location in the data structure comprises providing access to the Diameter message by the second processing node via a software pointer to the location in the data structure.

11. The method of claim 8, further comprising:
generating another Diameter message from the first processing node; and
transferring the other Diameter message to a third processing node via a Diameter base protocol, wherein the third processing node is configured within an external network element.

12. The method of claim 8, further comprising providing a Diameter bus between the first and second processing nodes, wherein the Diameter bus emulates a transport connection between the first and second processing nodes using Capabilities Exchange messages of a Diameter base protocol.

13. The method of claim 8, further comprising providing a Diameter bus between the first and second processing nodes, wherein the Diameter bus emulates a transport connection between the first and second processing nodes using a portion of a Diameter base protocol, wherein the portion of the Diameter base protocol is independent of Device Watchdog messages.

14. The method of claim 8, further comprising providing a Diameter bus between the first and second processing nodes, wherein the Diameter bus emulates a transport connection between the first and second processing nodes using a portion of a Diameter base protocol, wherein the portion of the Diameter base protocol is independent of external transport formatting.

15. An IMS network element, comprising:
a plurality of IMS processing nodes comprising first and second IMS processing nodes;
a communication interface adapted to communicate with an external IMS network element via a Diameter base protocol; and
a Diameter bus adapted to communicatively couple the IMS processing nodes, wherein the Diameter bus comprises a data structure adapted to receive a Diameter message at a first storage location in the data structure from the first IMS processing node and to transfer the Diameter message to the second IMS processing node.

16. The IMS network element of claim 15, wherein the Diameter bus is further adapted to emulate a transport connection between first and second IMS processing nodes using Capabilities Exchange messages of the Diameter base protocol.

17. The IMS network element of claim 15, wherein the Diameter bus is adapted to link the Diameter message to a first IMS processing node via a software pointer.

18. The IMS network element of claim 15, wherein the second IMS processing node is adapted to determine when a software pointer references a Diameter message intended for the second IMS processing node and wherein the second IMS processing node is adapted to retrieve the Diameter message from the data structure by a dereferencing of the software pointer.

19. The IMS network element of claim 15, wherein the first IMS processing node is adapted to generate a Diameter message and transfer the Diameter message to a third IMS processing node via the Diameter base protocol, wherein the third IMS processing node is configured within an external network element.

20. The IMS network element of claim 15, wherein the Diameter bus includes a simplified Diameter transport structure that uses only a portion of the Diameter base protocol, wherein the portion of the Diameter base protocol is independent of Device Watchdog messages and external transport encoding.
